(19) United States
(12) Patent Application Publication
(10) Pub. No.: US 2004/0023090 A1
(43) Pub. Date: Feb. 5, 2004

(54) Fuel cell system

(76) Inventors: Kenneth E. Pearson, Shingle Springs, CA (US); Glenn M. Dunn, Fair Oaks, CA (US)

Correspondence Address: COOLEY GODWARD, LLP, 3000 EL CAMINO REAL, 5 PALO ALTO SQUARE, PALO ALTO, CA, 94306, US

(21) Appl. No.: 10/402,726

(22) Filed: Mar. 28, 2003

Related U.S. Application Data
(60) Provisional application No. 60/369,183, filed on Mar. 30, 2002.

(51) Int. Cl. H01M 8/10; H01M 2/08; H01M 8/24

(52) U.S. Cl. 429/30; 429/38; 429/35; 429/32

(57) ABSTRACT

A proton exchange membrane (“PEM”) fuel cell stack and components of the fuel cell stack are provided. The fuel cell employs a plurality unique manifold assembly devices that allows for even distribution of the fuel source, e.g., hydrogen, to the anode side of the PEM and is designed so that the entrance orifice for the fuel source is larger than the exit orifice for the fuel source and/or reaction products. A pressure sensitive seal or a flexible, contoured seal is positioned around perimeter borders of the anode face of the PEM and the bipolar separation plate (“BSP”) to form a seal between the BSP and PEM. A sleeve, which is open-D-shaped in cross-section is provided that allows for even distribution of pressure on assembly of multiple fuel cells to form a fuel cell stack of the invention.

### RELATED APPLICATIONS

This application claims priority to U.S. Provisional Application No. 60/369,183 filed Mar. 30, 2002, and entitled “Compression Fuel Cell Stack System and Interlocking Wedge Seals” and hereby converts the provisional application into a utility application.

### FIELD OF INVENTION

This invention relates to an improved proton exchange membrane (PEM) fuel cell technology.

### BACKGROUND OF INVENTION

A PEM fuel cell uses a fuel source, such as hydrogen, and an oxygen source, such as air, to generate electrical energy through an electrochemical process. PEM fuel cells are known to be environmentally friendly generating only water and heat as byproducts of the electrochemical reaction.

A PEM fuel cell employs an electrolyte sheet of solid polymer that allows protons to be transferred from one face of the sheet at which a fuel source (e.g. hydrogen or methanol) is provided, to the other face of the sheet, at which oxygen, or air, is provided. The sheet is usually a sulfonic acid polymer (e.g. Nafion™), which is well-known in the art and commercially available from, e.g., W. L. Gore. The hydrogen/methanol face of the sheet is referred to as the anode and is negatively charged (i.e. it has an excess of electrons due to the flow of protons from the hydrogen/methanol face of the PEM to the air/oxygen face of the PEM). The air/oxygen face is referred to as the cathode and is positively charged (i.e. it has an excess of protons flowing to it). Thus, if an external wire connects the anode and cathode, electrons will flow from the former to the latter as direct current. The PEM sheet is encased in a bipolar separator plate (“BSP”) that is about the same dimension as the PEM. The face of the BSP facing the anode side of the PEM has channels formed therein to provide a flow path for the hydrogen or methanol to reach the PEM surface to provide an ongoing source of protons to cross the PEM to the cathode side. An entrance orifice is provided to the channels from a source of hydrogen or methanol and an exit orifice if needed in the case of methanol for the CO₂ formed from the methanol. Facing the cathode side of the PEM is another BSP having channels formed therein that provide a pathway for oxygen or air to react with the protons at the cathode face to form water and release heat. An entrance orifice is provided to the channels from an oxygen or air source and an exit orifice is provided for the water formed as a result of the reaction of oxygen with the protons. A fuel cell can be combined with other cells to form a fuel cell stack.

Multiple fuel cells typically consist of alternating layers of BSP's, and PEM's with seals or gaskets that must seal the gases from escaping each individual fuel cell. The fuel cells are held together with tie rods, clips, bolts or other means known to one trained in the mechanical arts. The separation of the hydrogen or methanol from the oxygen or oxygen rich gas mixture is critical to the performance of the fuel cell. The voltage output of a fuel cell stack is a function of the number of cells connected electrically in series and the electrical load supplied by the stack.

Electrical energy created in the fuel cell has to travel between layers of material compressed together before it can be used. These layers include membrane electrode assemblies, gas diffusion layers, separator plates etc. The resistance to the transfer of electrical energy through each layer and between layers also affects the performance of the fuel cell. The contact pressure and contact area that can be achieved between the layers of the fuel cell stack is directly proportional to the conductivity of these components and hence the performance of the fuel cell stacks.

Laying out layers of material and compressing them together using the brute force approach of traditional fuel cell stacks is inefficient and expensive. In addition, such designs suffer from long term performance degradation because of thermal and mechanical cycles that occur during the operation of the fuel cell.

In manufacturing fuel cell stack assemblies using this typical layering approach of all the components, it is difficult to accurately align the layers. Inaccurate alignment has a detrimental effect on the performance and durability of the fuel cell stack. Inaccurate alignment leads to ineffective sealing of the Proton Exchange Membrane (PEM) and Bi Polar Separator Plate (BSP) and to cleanliness issues. Thus, assembly of the stack becomes laborious and costly with rework typically needed on an abnormally high percentage of stacks.

This invention is directed at solving some of these difficulties.

### SUMMARY OF THE INVENTION

One aspect of this invention is a fuel cell that comprises

a proton exchange membrane (“PEM”) sheet having an anode face, a cathode face, and a perimeter having a border for positioning a seal on the anode face of the PEM sheet at the sheet's border and

a bipolar separator plate (“BSP”), having about the same dimensions as the PEM sheet and having interconnected channels in the face of the plate, for positioning adjacent the anode face of the PEM sheet, wherein the channels are separated by flat, raised surfaces, an entrance orifice leads to the channels for providing a fuel source to the anode face, an exit orifice leads from the channels for releasing reaction products from the anode face, and the perimeter of the BSP has a border for positioning a seal to mate with the border of the anode face of the PEM sheet,

wherein the cathode face of the PEM is exposed to an oxygen source to react with the protons crossing the PEM and wherein the entrance orifice for the fuel source is larger than the exit orifice for the reaction products.

Another aspect of this invention is a fuel cell stack that comprises a plurality of fuel cells as described that are arranged so that the BSPs are electrically connected in a manner that allows an electric current to flow.

Another aspect of this invention is a manifold assembly device that comprises

a longitudinal arm having a thickness, a width and length;

the arm having an aperture extending through the thickness at an end of the length of the arm;

a channel in a face of the arm, which channel communicates with the aperture;

a groove surrounding the channel and aperture in the same face of the arm having the channel, the groove being suitable for receiving a sealing ring;

a first extension wing extending from an end of the longitudinal arm having the aperture therethrough, the first wing having a hole therethrough, and

a second extension wing extending from the end of the longitudinal arm opposite from the end with the aperture therethrough, the second wing also having a hole therethrough.

Another aspect of this invention is an assembly of a plurality of the manifold assembly devices, wherein each device is positioned so that the apertures of each adjacent device align with each other to form a flow path for a fluid through the apertures and into the channels and the adjacent holes of each wing align so that a rod can be inserted therethrough to aid in fastening the devices together.

Still another aspect of this invention is a sleeve defined by a thin metal sheet, wherein the sheet has two longitudinal edges and two edges perpendicular thereto and is bent longitudinally so that the longitudinal edges parallel each other to form a longitudinal gap on one side of the sleeve, the other side of the sleeve forming a face having a plurality of slots in the face that are perpendicular to the length of the sleeve, thus leaving parallel metal strips across the length of the sleeve and two continuous longitudinal, flat method surfaces running the length of the sleeve and opposite the slotted face of the sleeve.

The sleeve preferably is designed to have the external surfaces of the metal strips slightly convex.

Still another aspect of this invention is a thin rectangular, flat metal sheet useful for forming the sleeve of this invention, the sheet having two longitudinal edges and two edges perpendicular thereto, wherein a plurality of parallel slots are located perpendicular to the longitudinal dimension of the sheet and extending only part way between longitudinal borders at each longitudinal edge of the sheet, and wherein each edge perpendicular to the sheet's longitudinal dimension has a flat border.

Still another aspect of this invention is a fuel cell that comprises

a proton exchange membrane (“PEM”) sheet having an anode face, a cathode face, and an inactive border around the sheet's perimeter, wherein a seal is positioned around the border of the anode face;

a bipolar separator plate (“BSP”) having about the same dimensions as the PEM sheet, the BSP having interconnected channels in the face of the plate for positioning adjacent the anode face of the PEM sheet, a entrance orifice leading to the channels to direct a fuel source to the anode face, the channels having flat raised surfaces between the channels, an exit orifice leading from the channels for releasing reaction products from the anode face, and a border around the BSP's perimeter to sealingly receive a seal between the perimeter border of the BSP and the anode face of the PEM sheet,

a plurality of conductive sleeves as defined in herein positioned across the cathode face of the PEM so that the continuous, longitudinal flat metal surfaces of the conductive sleeve are against the cathode face and the plurality of slots are aligned parallel to the channels and the parallel metal strips across the face of the sleeve are aligned with the flat raised surfaces between the channels of the BSP;

two manifold assembly devices (“MADs”) positioned at opposite ends of the fuel cell so that the top surfaces of each of the MADs are about level with the faces of the sleeves and the opposite surfaces of the MADs are tightly positioned against the inactive border of the cathode face of the PEM,

wherein on the end of the fuel cell having the entrance orifice leading to the channels, the MAD provides a passage to the entrance orifice, and on the end of the fuel cell having the exit orifice, the MADs provide a passage from the exit orifice to the atmosphere, so that when a fuel source is provided to the cell through the entrance orifice, it flows through the channels to contact the anode face of the PEM and at the same time an oxygen source flows through the sleeves to contact the cathode face to induce the flow of protons across the PEM and an electric current to flow from the anode to the cathode when a circuit is set up.

Still another aspect of this invention is a fuel cell stack that comprises a plurality of fuel cells as described layered together in the following repeated sequence:

a BSP with a channeled face,

a PEM with its anode face against the BSP's channeled face,

a seal between the perimeter borders of the BSP and the PEM,

a set of MADs and the conductive sleeves positioned on the cathode face.

Other aspects of the invention will be apparent to one of skill in the art upon reading the following detailed description and claims.

This it can be seen that a system of conductive sleeves or open D shaped compressive members help connect one cell assembly to the one immediately adjacent to it in the fuel cell stack to create a path to transfer the electrical energy produced by the fuel cell stack and by virtue of their design include a path for flow of oxidant to the fuel cell active area. A novel system of manifolds accurately controls the amount of compression of the sleeves or open D-shaped members to allow flat and parallel contact with the PEM and the interlocking seal. The manifolds distribute fluids to and from each of the individual cells which in addition includes design features that help improve the fuel cell performance. The manifolds designed to distribute a fuel source to and from each of the individual cells which provides a pressure differential between supply and demand of each individual cell. The fuel cell stack system of this invention utilizes Surface Mount Technology equipment utilized in the electronics industry for high rate manufacturing.

### BRIEF DESCRIPTION OF THE DRAWING

FIG. 1 is a simplified perspective view of a fuel cell stack assembly.

FIGS. 2A, 2B, 2C and 2D are simplified isometric views of certain components of a fuel cell illustrating the interaction of the manifold assembly device and the perimeter seals of the BSP and PEM.

FIG. 3A is a offset isometric view of interlocking contoured seals that are useful as the seals of FIGS. 2A and 2B.

FIG. 3B is a cross-sectional view of the interlocking seal demonstrating the cooperation between the wedges and grooves and the interlocking hooks and notches.

FIG. 4A is a simplified perspective view of a single conductive sleeve or open D-shaped member.

FIG. 4B is a side view of an open-D-shaped member useful for compressively retaining the fuel cell of this invention.

FIG. 5A is a top down partial cut away view of a fuel cell illustrating a PEM cell assembly with a manifold, BSP and PEM.

FIG. 5B is a top down view of a fuel cell having the conductive sleeves in place.

FIG. 6 is a cut-away perspective view of the fuel cell stack assembly of FIG. 1 illustrating various preferred embodiments.

FIG. 7A is a perspective overview of a fuel cell as used in the fuel cell stack assembly of FIG. 1 illustrating the positioning of the conductive sleeves or open D-shaped members.

FIG. 7B is a side view in the direction of the arrows in FIG. 7A.

FIG. 8 is a sectional view of a preferred interlocking seal and manifold.

FIG. 9 is a sectional view of the interlocking wedge seal and an open D-shaped member of FIG. 5.

FIG. 10 illustrates a portion of the interlocking flexible seal of FIGS. 3A & 3B with an example of an attachment of the seal to the PEM.

FIG. 11 is a side view of a portion of an assembled fuel cell of FIG. 1 illustrating how the manifold controls the accuracy and compression of open D-shaped members against the PEM and BSP.

FIG. 12 is a cross sectional, perspective view of open D-shaped members showing the grooves in the open D-shaped member that align with the hydrogen passage grooves in the BSP to facilitate better flow.

FIG. 13 is a cross sectional assembled view of the open D-shaped member or sleeve showing how the sleeve facilitates air flow.

### DETAILED DESCRIPTION OF INVENTION AND PREFERRED EMBODIMENTS

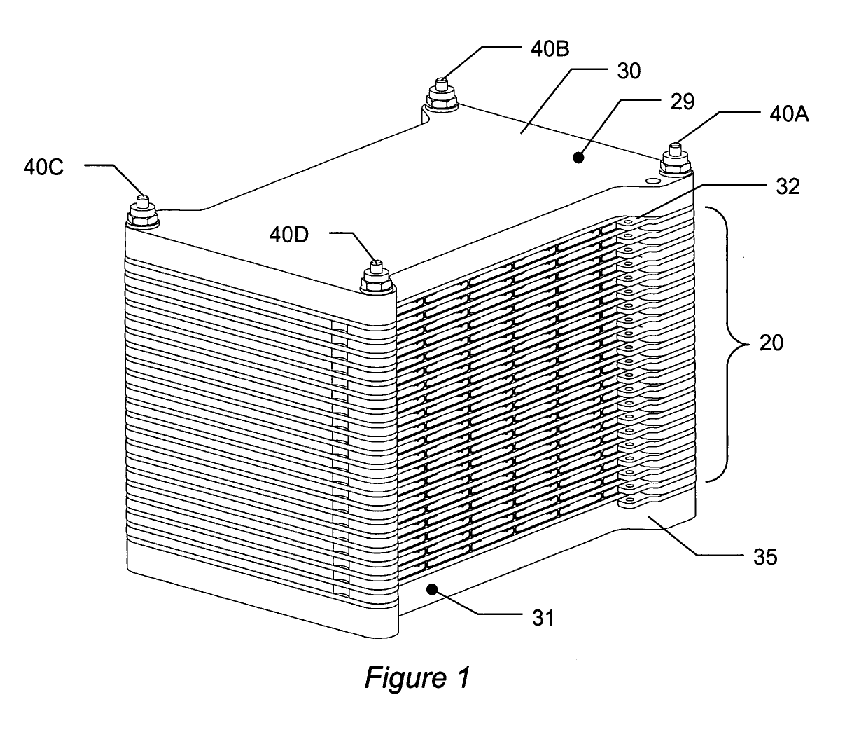

FIG. 1 represents a fuel cell stack that is comprised of multiple PEM fuel cells (20) that are sandwiched between endplates (30, 35). Tie rods or bolts (40A, 40B, 40C, 40D) are used to mechanically compress and hold the sandwich of 20 fuel cells collectively shown (20) between the end plates (30, 35).

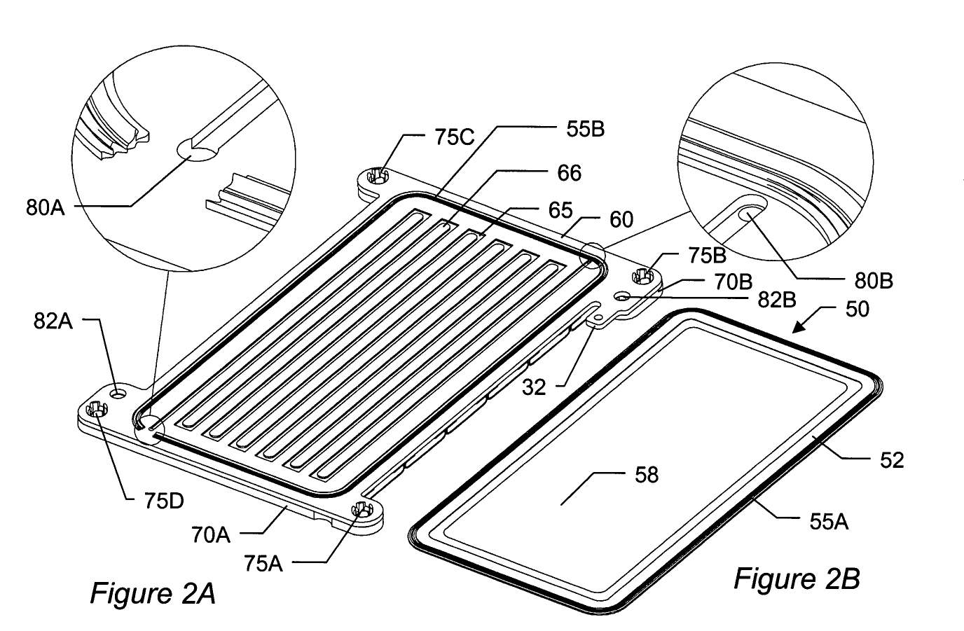

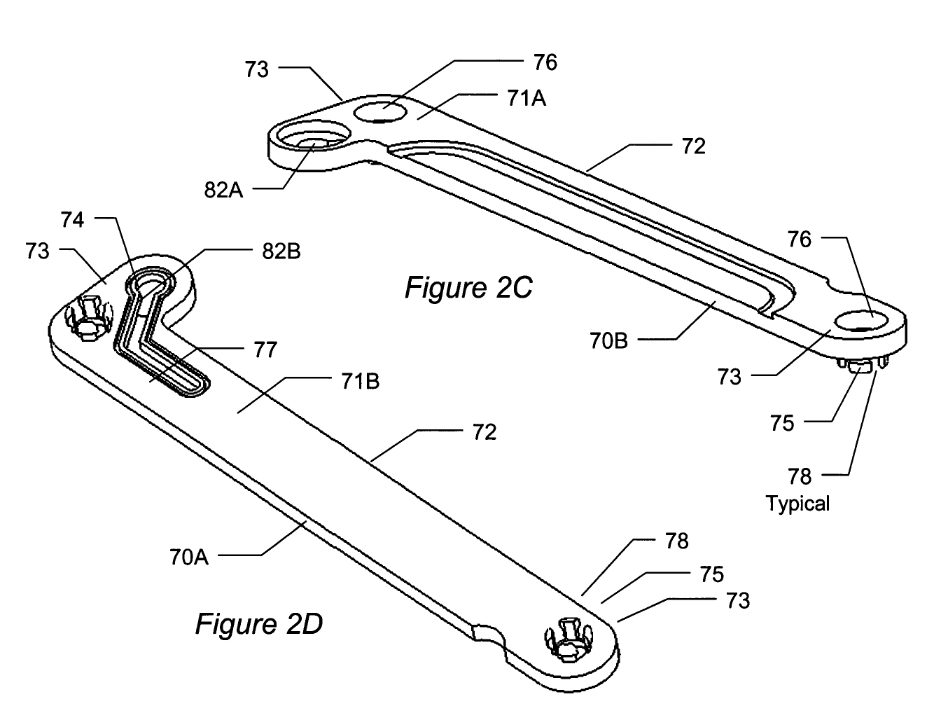

FIGS. 2A, 2B illustrate the basic components of a proton exchange membrane fuel cell useful in the stack shown as (20) in FIG. 1.

Each cell (20) is an assembly in which a proton exchange membrane (50) is attached to a bipolar separator plate (60) that may be associated with the unique manifolds of this invention (70A, 70B) that route hydrogen gas or methanol to and from the anode side of the proton exchange membrane (50) and the parallel or serpentine interconnected grooves or channels (65) in the face of separator plate (60). These channels (65) are separated by raised surfaces or lands (66) and provide a path for fluid flow to the active area of the membrane cell (58). As shown in FIG. 2A one face of the BSP is exposed. The unexposed face is flat.

The channels (65) are provided to allow a fuel source for protons (e.g. a fuel of hydrogen or methanol) to flow past the anode face (58) of the PEM (50). An entrance orifice is provided for the fuel source and an exit orifice is provided for the release of reaction products as needed. These orifices may be seen as (80A) and (80B) in FIG. 2A. Preferably the entrance orifices is larger than the exit orifice and a seal is positioned around the perimeter borders of the faces shown. In the specific example shown seals (55A and 55B) have contoured surfaces that interlock.

Thus, one can be that one aspect of this invention is a fuel cell that comprises

a proton exchange membrane (“PEM”) sheet having an anode face, a cathode face, and a perimeter having a border for positioning a seal on the anode face of the PEM sheet at the sheet's border and

a bipolar separator plate (“BSP”) having about the same dimensions as the PEM sheet and having interconnected channels in the face of the plate for positioning adjacent the anode face of the PEM sheet, wherein the channels are separated by flat, raised surfaces, an entrance orifice leads to the channels for providing a fuel source to the anode face, an exit orifice leads from the channels for releasing reaction products from the anode face, and the perimeter of the BSP has a border for positioning a seal to mate with the border of the anode face of the PEM sheet,

wherein the cathode face of the PEM is exposed to an oxygen source to react with the protons crossing the PEM and wherein the entrance orifice for the fuel source is larger than the exit orifice for the reaction products. Preferably the exit orifice has a cross-sectional area that is about 1/10 to about 1/2 of the cross-sectional area of the entrance orifice and the fuel source is hydrogen at an elevated pressure. The hydrogen is provided to the fuel cell at the anode face at a pressure of about 2 psi to about 5 psi and is reduced prior to entry to the fuel cell using a pressure regulator.

Further referring to FIGS. 2A and 2B, one can see another aspect of the invention, namely a PEM (50) having a perimeter seal (55A) attached to the border. The seal could be contoured as discussed hereinafter, or could comprise a pressure-sensitive adhesive (“psa”) seal, wherein, for example one side of psa would adhere to the border of PEM (50) while the other side of the psa would have a removable covering sheet. The psa seal would have a cut out portion for the two orifices in the BSP if needed. Alternatively the psa seal could be located around the perimeter border of BSP (60) as shown at (55B). In either case the cover sheet of the psa seal is pealed off and the two portions shown in FIGS. 2A and 2B are then easily joined. Such psa seals are available from JDC Company and are of a thickness of 0.005-0.010 inches or so.

FIGS. 2C, 2D illustrate in another embodiment wherein channels (65) are fed by a plurality of manifold assembly devices (70A, 70B) via one or more inlet ports (82A, 82B) and passages (77). FIG. 2D shows the device in FIG. 2C flipped over.

The manifold assembly device of this invention comprises a longitudinal arm (72) having a thickness, a width and length as shown in FIGS. 2C and 2D. The device is made of a rigid, but pliable material, such as a plastic. The arm (72) has an aperture (82A, 82B) extending through the thickness at an end (73) of the length of the arm. A channel (77) is carved into a face of the arm communicating with the aperture, (82B) in FIG. 2D. A groove (74) surrounds the channel (77) and aperture (82B), the groove being suitable for receiving a compressible sealing ring, not shown. Because the manifold assembly devices will be stacked together to provide fluid pathways, a first extension (73) wing extends from the end of the longitudinal arm (72) having the aperture (82A) therethrough, the first wing having a hole (76) therethrough, and a second extension wing (73′) extending from the end of the longitudinal arm opposite from the end with the aperture therethrough, the second wing also having a hole (76′) therethrough. The extension wings may simply be logitudinal extension of the arm (72) or the first and/or second wings may extend perpendicularly on the same side on opposite sides from the longitudinal arm. Preferably each hole on each wing has a positioning lip or lips extending around the hole on one side of the thickness of the device.

The manifolds preferably have positioning lips or alignment nubs (75A, 75B, 75C, 75D in FIG. 2A) that may have notches (78) that allow the manifold to clip into the bi-polar separator plate (60) and other stacked manifold assembly devices to aid alignment of the fuel cell stack assembly. As shown in FIG. 2A, the manifold fits around the end perimeters of the separator plate. By ensuring each manifold used in a fuel cell stack as shown in FIG. 1 has the exact thickness between parallel surfaces (71A, 71B), the distance between each bi-polar separator plate (60) is accurately controlled.

Thus, each anode bi-polar separator plate (60) can be connected to the source of fuel through a plurality of manifold assembly devices (70A, 70B), wherein each manifold device is positioned so that the apertures of each adjacent device align with each other to form a flow path for a fluid through the apertures, into the groove, and thence into the channels of each BSP. Adjacent holes of each wing align so that a rod can be inserted therethrough to aid in fastening the devices together to form a fuel cell stack. Each bi-polar separator plate (60) may have multiple holes (80A, 80B) for entry and exit of the channels (65) or openings (82A, 82B) for fastening rods, and the PEMs are sandwiched between the separator plates. As shown the PEMs do not require such fastening rod holes.

Each bipolar separator plate (60) may have multiple holes (80A, 80B) that are use to control pressure differentials between the pressure of the supply of hydrogen or methanol to the stack and the pressure of hydrogen in each cell. By having the exit orifice smaller than the entrance orifice, the hydrogen pressure in each cell is equalized. The fuel cell stack as visualized in FIGS. 1, 6, and 11-13 has an exit for the exhaust gas, primarily hydrogen, that is regulated by a valve that is generally closed, thus creating a pressurized system. Hydrogen flows out of the system only when the exhaust valve is opened. Because of the smaller exit orifice the hydrogen pressure in each cell will be equalized. An exhaust valve useful for this purpose can be obtained from the Lee Co., Essex, Conn., as a 5 volt 15 PSID max valve.

In one embodiment a flexible, contoured seal (55A) is attached to the inactive area (52) that forms the outer edge or perimeter of the proton exchange membrane (50). Another flexible, contoured seal (55B) is attached to the perimeter area of the bipolar separator plate (60) such that the dimensions and area contained within the seal (55B) is sufficiently equal to the dimensions and area contained within the proton exchange membrane's seal member (55A). Thus, when the PEM (50) is placed so that its face (58) is positioned against the face of the BSP (60), the flexible, contoured seal (55A) will be sealingly received by the flexible, contoured seal (55B) of the BSP to form a tight seal. Because the seal is flexible (i.e. compressible or pliable) compressing multiple fuel cells together will not create undue stress on the systems.

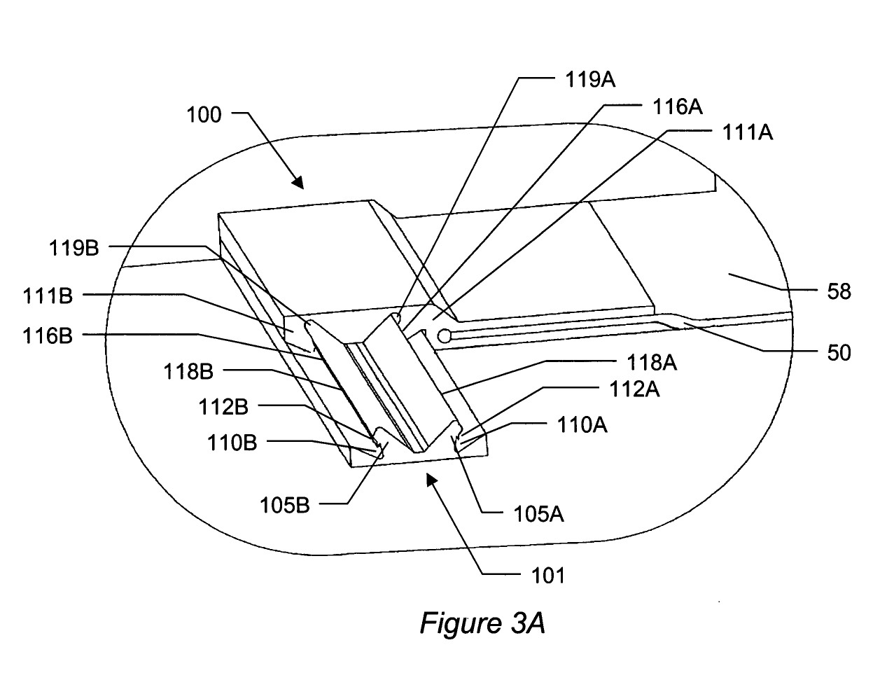

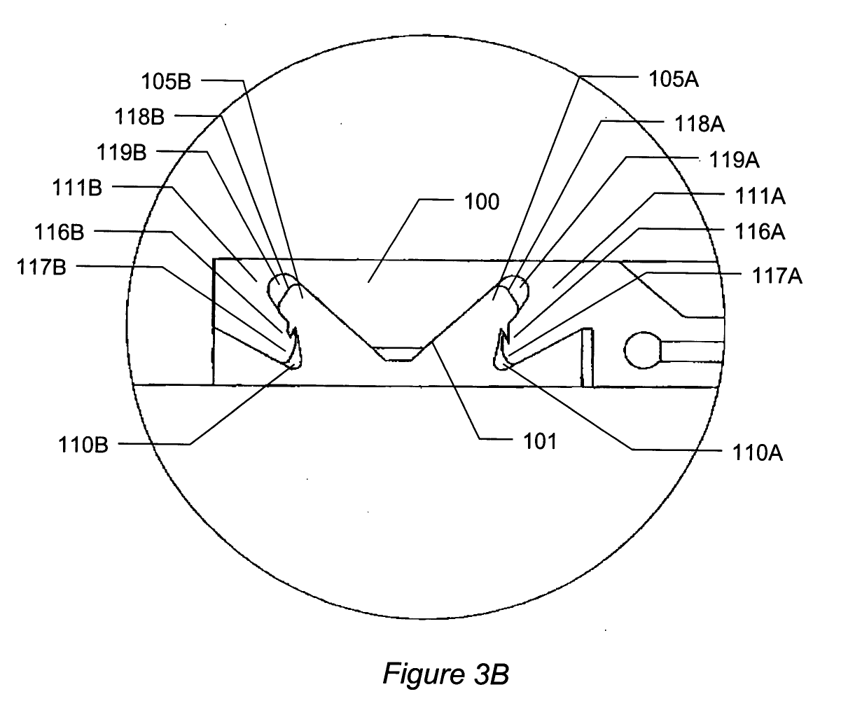

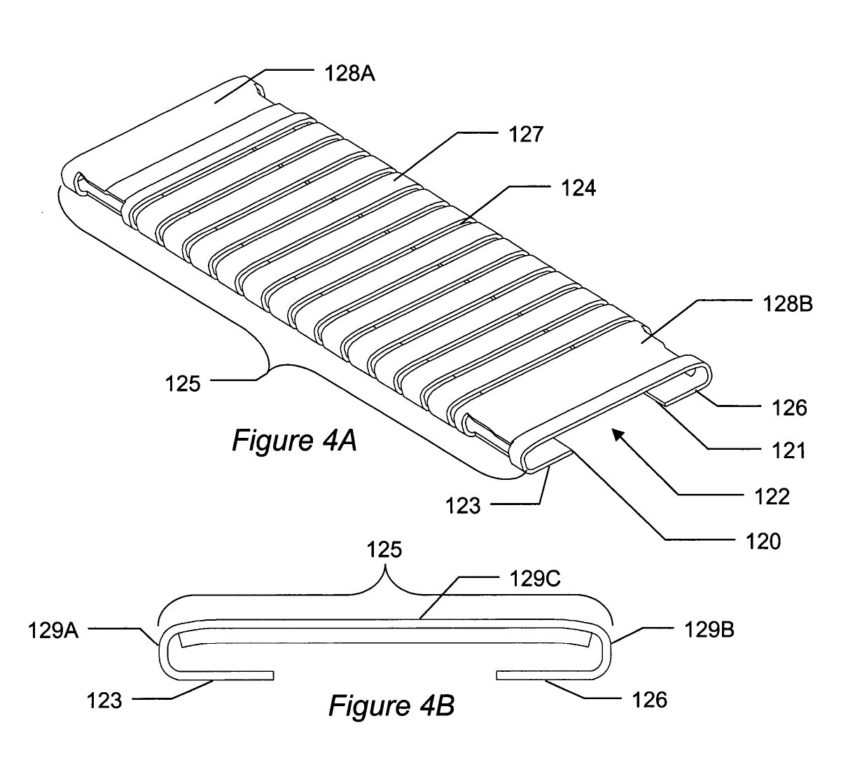

FIG. 3A illustrates a preferred embodiment of a flexible, contoured seal (100) that is used to attach and seal the proton exchange membrane of FIG. 2B to the bi-polar separator plate of FIG. 2A. The design shown is an interlocking, contoured flexible seal (100). When the active face on the anode side of proton exchange membrane (50) is positioned adjacent and covering the BSP, interconnected grooves (65) facilitate the transfer of protons across the PEM when a fuel is provided to the channels (65) and oxygen is provided on the opposite face of the PEM (50).

The interlocking, contoured flexible seal (100, 101) is preferably substantially impermeable to hydrogen, although it need not be absolutely impermeable. The contoured flexible seal (100, 101) may be made from silicone, neoprene or other suitable elastomeric material.

In the preferred embodiment of FIG. 3A the contoured flexible seal is shown as a plurality of complementary interlocking wedges (105A, 105B, 111A, 111B) and tapered grooves (110A, 110B, 119A, 119B) around the perimeter each proton exchange membrane (50) and bipolar separator plate (60).

One part of the interlocking seal (100) is shown to slip over the perimeter border of PEM (50) without interfering with active face (58). This can be seen on a larger scale in FIG. 2B. Seal (100) in FIG. 3A corresponds to seal (55A) in FIG. 2B, while seal (101) of FIG. 3A corresponds to seal (55B) in FIG. 2A. Thus, it can be seen that a seal is positioned on the border around the perimeter of the BSP that sealingly engages the border around the perimeter of the PEM so that the fuel source is contained within the channels. The border around the perimeter of the PEM and the perimeter border of BSP each have a flexible, contoured seal, wherein each seal interacts with the other to provide a substantially leak proof environment for the fuel source, and the preferred design shows that each perimeter seal has a plurality of interlocking flexible features facilitates sealing.

FIG. 3B illustrates in an embodiment where the wedges (105A, 105B, 111A, 111B) fit into the tapered grooves (110A, 110B, 119A, 119B) so that the wedges (105A, 105B, 111A, 111B) on one member are positioned to sealingly fit into the tapered groove (110A, 110B, 119A, 119B) on the other member when the proton exchange membrane (50) and bi-polar separator plate (60) are assembled, thus preventing a leakage.

In another embodiment within this embodiment the inner wedges (105A, 105B) and outer wedges (111A, 111B) have angled or radiused noses (118A, 118B, 117A, 117B) that are positioned to slide over and cause a temporary deformation of the seal. Once the nose section (118A, 118B, 117A, 117B) of the wedges (105A, 105B, 111A, 111B) are engaged within a tapered grooves (119A, 119B, 110A, 110B) on the opposite member so as to interlock when assembled.

In another embodiment the outer wedges (105A, 105B, 111A, 111B) and tapered grooves (110A, 110B, 119A, 119B) are flexible, as they can resiliently deform as a result of making contact with the center main wedge (108) as the proton exchange membrane (50) section compresses the center main groove (109) resulting in a tightening of the outer wedges (105A, 105B, 111A, 111B) and tapered grooves (110A, 110B, 119A, 119B) together to form a gas tight seal.

The angle of center wedge (100) and the angle of the center groove (101) may be varied from that shown, as may be the angle of inner and outer wedges (105A, 105B, 111A, 111B) and the angle of the outer grooves (110A, 110B, 119A, 119B). Thus, the contoured flexible seal extending around the perimeter of the PEM and BSP can be seen as a plurality of interlocking wedges (105A, 105B, 111A, 111B) and tapered grooves (110A, 110B, 119A, 119B). In a still further embodiment, hooks or barbs (112A, 112B) are received and interlock by notches (116A, 116B) to insure interlocking of the seal.

It can be seen that the use of the above embodiments facilitates the manufacturing process so that the seal members (55A, 55B) have corresponding features such that the proton exchange membrane (50) can be easily attached or detached to and from the bi polar separator plate (60).

FIGS. 4A and 4B illustrates another feature of this invention. This can be viewed as a sleeve or an open D-shaped member (125). Only one leg of the flat (126) section of the open D-shaped member (125) is attached to the bi-polar separator plate to allow slight expansion and contraction of the open D-shaped members/(125) in both the horizontal and vertical directions.

This D-shaped member can be described as an elongated sleeve, preferably conductive, defined by a thin metal sheet, that has two, 180° longitudinal bends (129A and 129B). The longitudinal edges (120, 121) parallel each other so there is a longitudinal gap (122) on one side of the sleeve. The other side of the sleeve forms a series of faces (127) and a plurality of slots (124) between the faces and that are perpendicular to the length of the sleeve. It can be seen that the parallel metal faces are perpendicular to the length of the sleeve, and two longitudinal metal surfaces (126, 129) run the length of the sleeve and opposite the parallel faces (127). Preferably the external surfaces of faces 127 are slightly convex, but the longitudinal surfaces (126, 129) are flat and smooth. The length of the sleeve may vary widely but preferably is about 1-5 inches, the width is about 0.5-1 inch, and the thickness (i.e. the distance from surface (123 or 126) to surface (127)) is about 0.05-0.2 inch. In a preferred aspect, there are about 10-25 slots (124) across the length of the sleeve. Thirteen slots are shown in FIG. 4A.

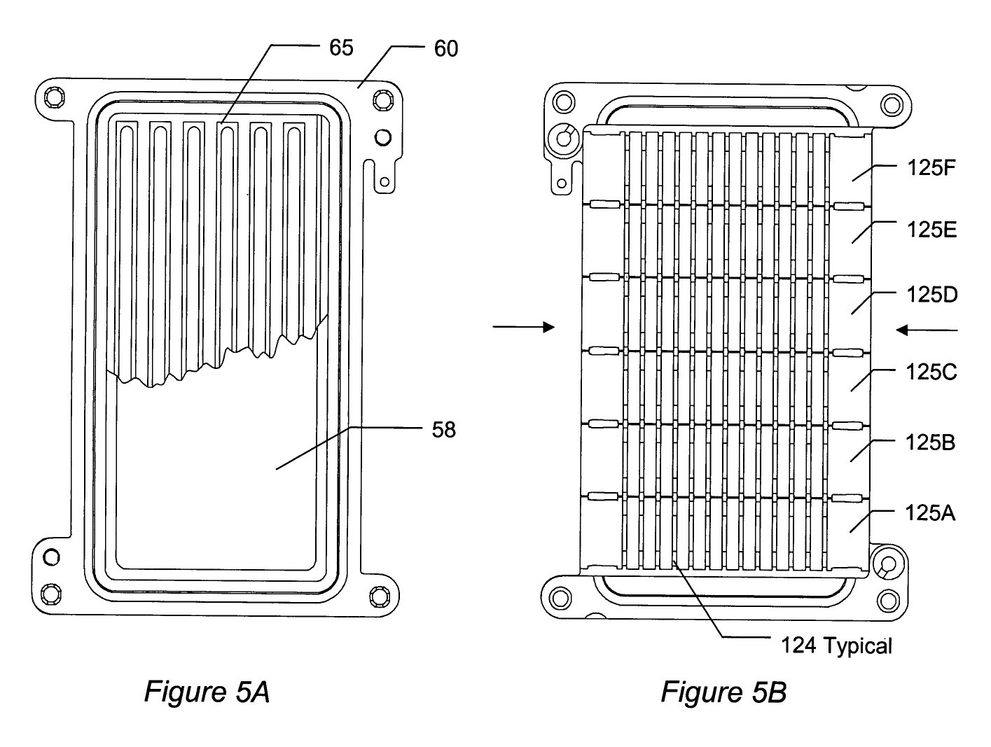

In another embodiment, the open D-shaped member (125) has flat surfaces (128A, 128B) at each end of the sleeve that are in direct alignment with the seals (55A, 55B in FIGS. 2A and 2B) to accurately compress the seals together. See also FIGS. 5A and 5B. Preferably the seals are interlocking, as discussed above. The plurality of faces or lands (127) are directly aligned with the raises surfaces or lands (66) of the bi polar separator plate as shown in FIG. 2A. This ensures the proper compression of the proton exchange membrane to even predetermined pressures against the bipolar separator plate (60) when in the fuel cell assembly. The plurality of slots (124 in FIGS. 4A and 5B) are in direct alignment with the channels (65) of the bi polar separator plate as shown in FIG. 2A so that a fluid flows through the channels (65) of bi-polar separator plate (60) and past the PEM anode face to provide for the flow of protons across the PEM.

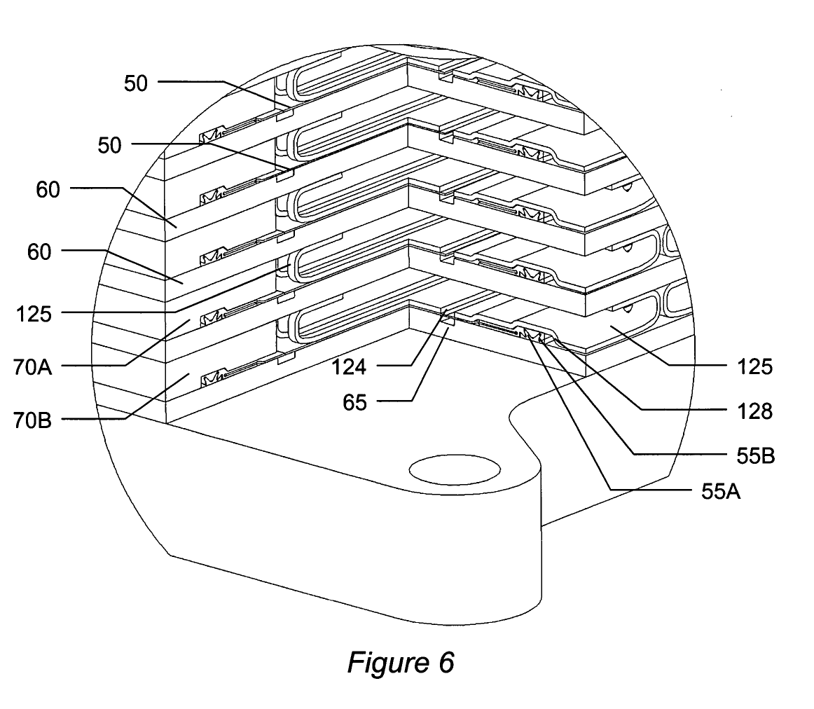

The open D-shaped member (125) has three convex radiuses or convexities (129A, 129B, 129C) that are designed to optimize (make flat at maximum pressure) the contact of the faces (127) of the open D-shaped member (125) when compressed in the fuel cell stack to the design height of the manifolds (70A, 70B) as shown individually in FIGS. 2C and 2D and as a collective in FIGS. 1 and 6 a membrane electrode assembly of FIG. 5A illustrates the active area (58) of a proton exchange membrane (50) is attached to the bipolar separator plate (60) directly above the fluid channels (65) that are fed with a fuel like hydrogen or methanol.

FIG. 5B illustrates the plurality of open D-shaped members (125A, 125B, 125C, 125D, 125E, 125F) having slots or openings (124) to aid or allow air circulation in the direction of the arrows to the proton exchange membrane improving performance of the fuel cell stack.

The sleeve is prepared by folding the borders of a thin metal, rectangular sheet that has a plurality of slots extending transverse to the length of the sheet between solid borders along the longitudinal sides of the sheet. The slotted, thin metal sheet is prepared by methods known in the art such as stamping, cutting, etching, and the like. This process results in a thin rectangular, flat metal sheet useful for forming the sleeve. The sheet has two longitudinal edges and two edges perpendicular thereto, wherein a plurality of parallel slots are located perpendicular to the longitudinal dimension of the sheet and extending only part way between longitudinal borders at each longitudinal edge of the sheet. Each edge perpendicular to the sheet's longitudinal dimension has a flat border. The dimensions of the sheet will vary depending on the desired size of the sleeve. Preferably the length is about one to about five inches, the width is about 0.5 inch to about five inches, and the thickness is about 0.001 inch to about 0.01 inch. Once the flat sheet is formed, it is bent 180° at two wing positions parallel to the longitudinal dimension to provide the sleeve as shown in FIGS. 4A and 4B having the radii shown at 129A and 129B.

In preparing a BSP or the flat sheet for the sleeve useful in this invention, the following etching process is useful:

Metal surfaces are de-greased and cleaned.

Metal is laminated with a photo sensitive, acid resistant plastic.

Laminated metal is sandwiched in between a clear Mylar photo tool which has the part features laser plotted onto both sides of the tool.

Laminated metal, in the photo tool, is placed into an imaging machine and exposed to white light.

Imaged sheets are developed in a solution of Potassium Carbonate.

Developed sheets are placed into an etching machine and while being slowly drawn through its length is being sprayed top and bottom with Ferric Chloride, an etchant. The Ferric Chloride attacks the exposed metal areas left behind by the developing process.

Etched blanks are stripped of their photo resist in an alkaline solution then sprayed clean in de-ionized water.

Finished blanks are inspected for dimensional integrity.

Once accepted, finished blanks are either shipped flat per the given drawing or may be sent to an outside vendor for forming of specific features per the given drawing. The surfaces may be coated for the desired characteristics with nickel, platinum, gold, and the like or coating using the passivation or the bright passivation technique, which know to those skilled in the art

Another aspect of this invention is a fuel cell stack that comprises a plurality of fuel cells as described herein layered together in the following repeating sequence.

a BSP with a channeled face,

a PEM with its anode face against the BSP's channeled face,

a seal between the perimeter borders of the BSP and the PEM,

a set of manifold assembly devices at the ends of the PEM & BSP, and the sleeves positioned on the cathode face.

The fuel cell stack may be positioned between a mounting plate and a back plate and have an electrical circuit established between the anode and cathodes of the PEMs. The stack is preferably designed to provide a system of increments of 12 volts. The number of fuel cell layers may vary from 10 to 40 or more. Preferably the range is 10-25. A single stack is designed generally to provide 12 volts, and multiple stacks can be combined to give 24, 36, 48, etc. volt systems.

Referring to FIG. 1, a back plate 30 and a mounting plate can be visualized as 35, may be modified to accommodate additional components useful to the operation of the fuel cell stack. Such components include the exhaust valve, not shown, that would be connected to the exit orifices of the BSPs through an internal channel in back plate 30 exiting through hole 29. In addition, a regulator, not shown, for the hydrogen pressure may be employed to reduce the H₂ pressure to the desired level. Such a regulator is obtainable from U.S. Paraplate at Auburn, Calif. The hydrogen is supplied to the entrance orifices of the BSP through an internal channel, not shown, in the mounting plate 35 through hole 31. In operation a potential exists between the electrical contacts of the BSP plates shown as 32 in FIG. 1 and FIG. 2A. By connecting wires at contacts 32, an electrical current can be drawn at the desired voltage. Preferably 20 fuel cells are stacked together. In addition air can be force circulated through the stacks shown by arrows in FIG. 5B by using a fan.

FIG. 6 is a cross sectional perspective view of the fuel cell stack of FIG. 1 illustrating how certain preferred features work together to form the fuel stack system of this invention.

The open D-shaped members (125) with surface (128) are positioned and dimensioned to compress the interlocking wedge seal (55A, 55B) that has been bonded, molded in, ultrasonically attached or adhered to the proton exchange membrane (50) and bipolar separator plate (60) assemblies. The manifolds (70A, 70B) have flat surfaces (72A, 72B) that are positioned and dimensioned to capture and compress the interlocking wedge seal (100) that has been bonded, molded in, ultrasonically attached or adhered to perimeter of the proton exchange membrane (50) and bi polar separator plate (60) assemblies. It can be seen that slots (124) and channels (65) align the fuel source (e.g. hydrogen or methanol) flow through channels (65) of the bi polar separator plate (60) to allow protons to flow from the anode side of PEM (58) to combine with oxygen on the cathode side of the PEM, which is provided by air circulation or other source of oxygen.

Open D-shaped members (125) are compressed flat and parallel to the thickness of manifolds (70A, 70B) to provide optimum performance of the fuel cell stack.

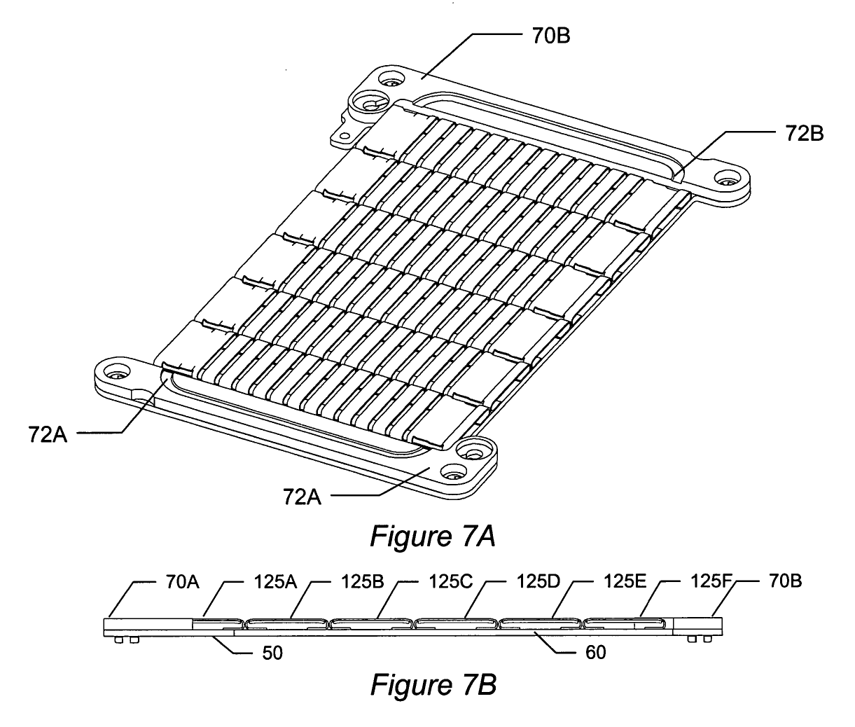

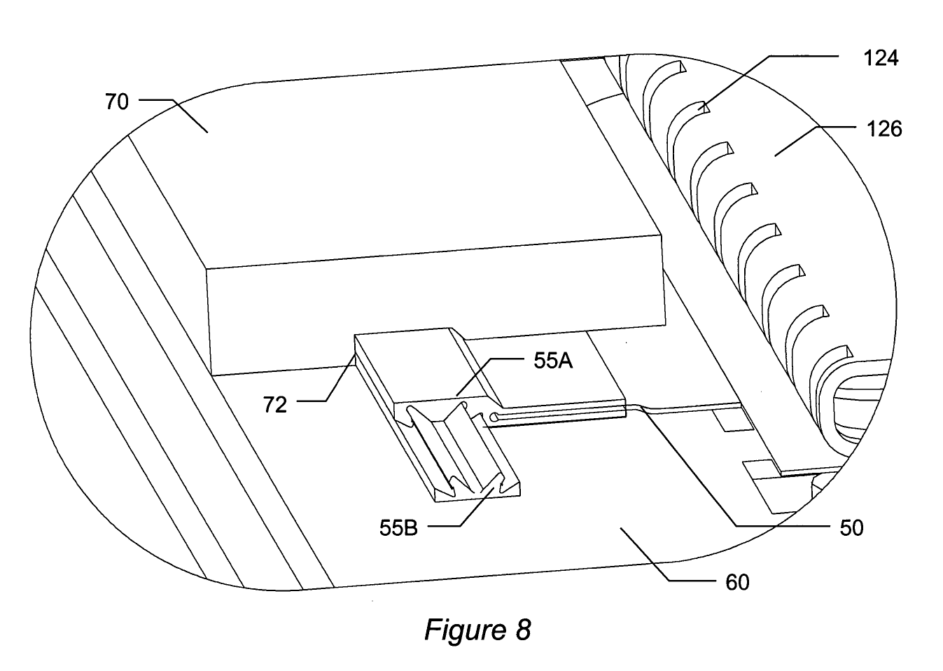

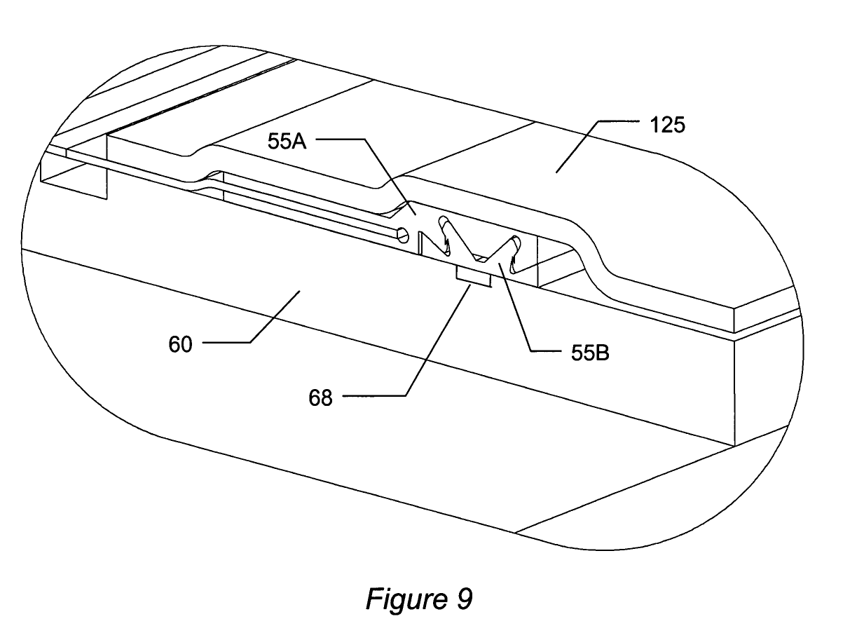

FIG. 7A illustrates another embodiment were the manifolds (70A, 70B) have grooves (72A, 72B) molded, machine, cut or otherwise dimensioned so as to capture an interlocking seal that can interact with a complementary seal the layer fitting on top of the face shown.

FIG. 7B illustrates a single layer of a fuel cell stack that employs manifolds (70A, 70B) at sides adjacent to the plurality of open D-shaped members (125A, 125B, 125C, 125D, 125E, 125F). The D-shaped members are dimensioned to be the same thickness as the thickness of the manifolds to precisely control the amount of compressive force of the open D-shaped members (125A, 125B, 125C, 125D, 125E, 125F) against the opposing proton exchange membrane (50) and bi polar separator plate (60) when a fuel cell stack is formed as shown in FIG. 1.

FIG. 8 is a cross sectional view of the embodiment of the manifold (70) and seals (55A, 55B) which consists of a plurality of interlocking wedges (105A, 105B, 111A, 111B), hooks (112A, 112B) and tapered grooves (110A, 110B, 116A, 1161B, 119A, 119B) as shown in FIG. 3. The groove (72A) of manifold (70A) can be seen to receive the interlocking seal (55A).

FIG. 9 is a cross sectional view of a detail of the system of open D-shaped member (125) and seals (55A and 55B) which consists of a plurality of interlocking wedges (105A, 105B, 111A, 111B), hooks (112A, 112B) and tapered grooves (110A, 110B, 116A, 116B, 119A, 119B) as shown in FIG. 3 in greater detail. The seal (55B) is mounted, adhered or molded into a groove (68) around the perimeter of the bi polar separator plate (60). The seal 55B is mounted, adhered or molded into a channel (68) around the perimeter of the bi-polar separator plate (60) in alignment with the seal on the perimeter of the proton exchange membrane (50).

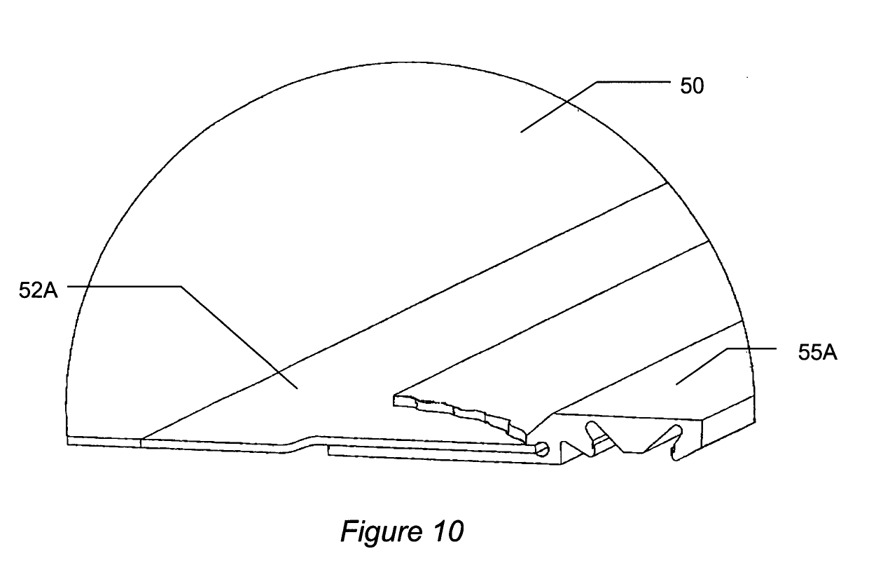

FIG. 10 is a cross sectional view, broken away for clarity, of the embodiment where the seal (55A) is ultrasonically mounted, adhered or sandwiched to inactive area (52) of the proton exchange membrane (50).

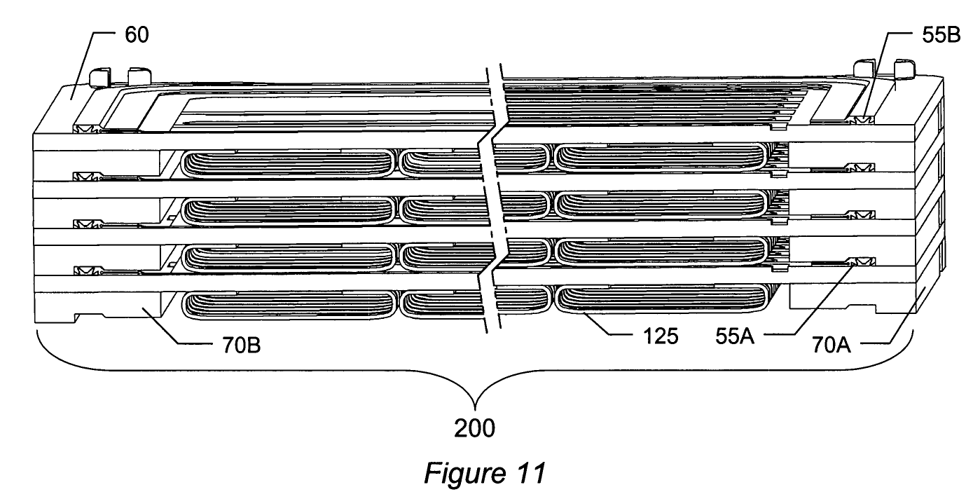

FIG. 11 is a simplified cross sectional view of the compressive fuel cell stack system (200) consisting of a plurality of cells (20), interlocking wedge seals (55A, 55B), bi polar separator plate (60), manifolds (70A, 70B) stack together. No end plates or tie rods are shown.

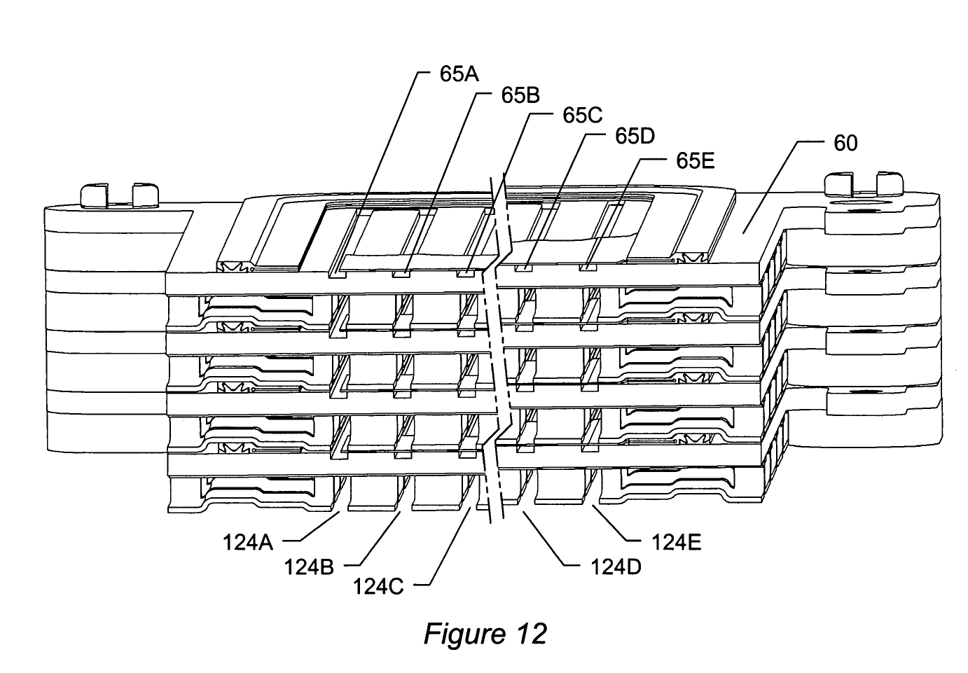

FIG. 12 is a cross sectional view of the embodiment compressive fuel cell stack system (200) illustrating how the grooves (65A, 65B 65C, 65D, 65E) in the bi polar separator plate (60) align with the slots (124A, 124B, 124C, 124D, 124E) in the D or open D-shaped members (125).

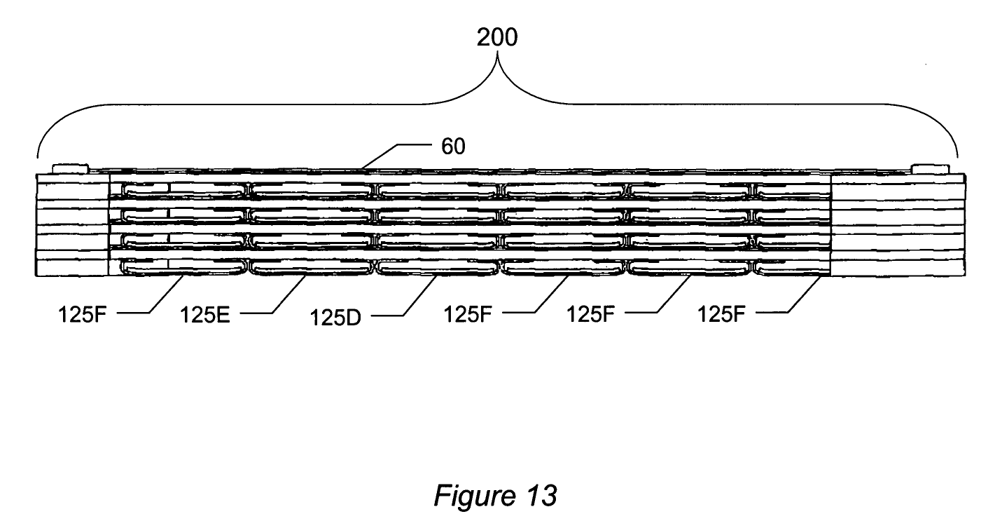

FIG. 13 is a side view of the embodiment of the compressive fuel cell stack system (200) demonstrating how the D or open D-shaped members (125A, 125B, 125C, 125D, 125E, 125F) and bi polar separator plate (60) aid active air and fluid flow through the fuel cell stack through channels (250) to allow heat and water management of the fuel cell stack, consisting of a plurality of cells stack together without end plates (30, 35) and tie rods (40A, 40B, 40C, 40D) of FIG. 1 to provide clarity of the preferred embodiment.

The subject matter claimed is:

1. A fuel cell that comprises
a proton exchange membrane (“PEM”) sheet having an anode face, a cathode face, and a perimeter having a border for positioning a seal on the anode face of the PEM sheet at the sheet's border and
a bipolar separator plate (“BSP”) having about the same dimensions as the PEM sheet and having interconnected channels in the face of the plate for positioning adjacent the anode face of the PEM sheet, wherein the channels are separated by flat, raised surfaces, an entrance orifice leads to the channels for providing a fuel source to the anode face, an exit orifice leads from the channels for releasing reaction products from the anode face, and the perimeter of the BSP has a border for positioning a seal to mate with the border of the anode face of the PEM sheet,
wherein the cathode face of the PEM is exposed to an oxygen source to react with the protons crossing the PEM and wherein the entrance orifice for the fuel source is larger than the exit orifice for the reaction products.

2. The fuel cell of claim 1, wherein the exit orifice has a cross-sectional area that is about 1/10 to about 1/2 of the cross-sectional area of the entrance orifice.

3. The fuel cell of claim 1, wherein the fuel source is hydrogen at an elevated pressure.

4. The fuel cell of claim 3, wherein the hydrogen is provided to the fuel cell at the anode face at a pressure of about 2 psi to about 5 psi.

5. The fuel cell of claim 4, wherein the elevated pressure of the hydrogen is reduced prior to entry to the fuel cell using a pressure regulator.

6. The fuel cell of claim 1, wherein a seal is positioned on the border around the perimeter of the BSP that sealingly engages the border around the perimeter of the PEM so that the fuel source is contained within the channels.

7. The fuel cell of claim 6, wherein the border around the perimeter of the PEM and the perimeter border of BSP each have a flexible, contoured seal, wherein each seal interacts with the other to provide a substantially leak proof environment for the fuel source.

8. The fuel cell of claim 7, wherein each perimeter seal has a plurality of interlocking flexible features to facilitate sealing.

9. The fuel cell of claim 7, wherein each perimeter seal has an interlocking series of wedges and grooves to prevent leakage of fluid between the PEM and the BSP.

10. The fuel cell of claim 7, wherein said perimeter flexible contoured seal is mounted, adhered or molded around the perimeter of the BSP.

11. The fuel cell of claim 7, wherein said perimeter flexible contoured seal is mounted, adhered, or ultrasonically attached to the perimeter of the PEM.

12. The fuel cell of claim 7, wherein flexible contoured seal is made from an elastomeric material.

13. The fuel cell of claim 7, wherein the perimeter flexible, contoured seals comprise plurality of angular surfaces that interlock when compressed.

14. The fuel cell of claim 7, wherein each perimeter flexible contoured seal has a plurality of interlocking hooks and notches.

15. A fuel cell of claim 14, wherein the flexible contoured seals have barbs dimensioned at nose sections of a plurality of interlocking wedges and grooves on the first member so as to interlock with the plurality of wedges on the second member.

16. The fuel cell of claim 1, wherein a pressure sensitive adhesive, flexible seal is positioned on the border of the BSP to provide a sealed environment for the fuel source in the fuel cell.

17. A fuel cell stack that comprises a plurality of fuel cells of claim 1 that are arranged so that the anode faces are electrically connected to the cathode faces in a manner that allows an electric current to flow from the anode to the cathode.

18. A manifold assembly device that comprises
a longitudinal arm having a thickness, a width and length;
the arm having an aperture extending through the thickness at an end of the length of the arm;
a channel in a face of the arm, which channel communicates with the aperture;
a groove surrounding the channel and aperture in the same face of the arm having the channel, the groove being suitable for receiving a sealing ring;
a first extension wing extending from an end of the longitudinal arm having the aperture therethrough, the first wing having a hole therethrough, and
a second extension wing extending from the end of the longitudinal arm opposite from the end with the aperture therethrough, the second wing also having a hole therethrough.

19. The manifold assembly device of claim 18, wherein the first and second wings extend perpendicularly on the same side from the longitudinal arm.

20. The manifold assembly device of claim 19, wherein each hole on each wing has a positioning lip extending around the hole on one side of the thickness of the device.

21. The manifold assembly device of claim 18, wherein a compressible sealing ring is positioned in the groove and optionally a compressible sealing ring is also positioned in the aperture on the face of the arm opposite from face in which the channel is located.

22. The manifold assembly device of claim 18, wherein the device is made of a rigid, but pliable material.

23. The manifold device of claim 22, wherein the material is a plastic.

24. The manifold assembly of claim 23, wherein the plastic is not permeable to hydrogen gas.

25. The manifold assembly device of claim 23, wherein the plastic is not reactive with methanol.

26. The device of claim 18 being about 3-5 inches in length, about 0.5-1 inch in width, and about 0.1 to about 0.3 inch thick.

27. A plurality of the manifold assembly devices of claim 18, wherein each device is positioned so that the apertures of each adjacent device align with each other to form a flow path for a fluid through the apertures and into the channels and the adjacent holes of each wing align so that a rod can be inserted therethrough to aid in fastening the devices together.

28. A sleeve defined by a thin metal sheet, wherein the sheet has two longitudinal edges and two edges perpendicular thereto and is bent longitudinally so that the longitudinal edges parallel each other to form a longitudinal gap on one side of the sleeve, the other side of the sleeve forming a face having a plurality of slots in the face that are perpendicular to the length of the sleeve, thus leaving parallel metal strips across the length of the sleeve and two continuous longitudinal, flat method surfaces running the length of the sleeve and opposite the slotted face of the sleeve.

29. The sleeve of claim 28, wherein the external surface of the metal strips is slightly convex.

30. The sleeve of claim 29, wherein the convexity of the external surfaces of the metal strips is designed to maximize contact and pressure when the external surfaces compressed.

31. The sleeve of claim 28 that is made from a stainless steel alloy.

32. The sleeve of claim 31, wherein the surface of the sleeve is coated with a nickel, platinum or gold alloy or is treated by a passivation or bright passivation technique.

33. The sleeve of claim 28, wherein the length is about one to about five inches, the width is about 0.5 inch to one inch, and the thickness is about 0.05 inch to about 0.2 inch.

34. The sleeve of claim 33, wherein there are about 10-25 slots across the length of the sleeve.

35. A thin rectangular, flat metal sheet useful for forming the sleeve of claim 28, the sheet having two longitudinal edges and two edges perpendicular thereto, wherein a plurality of parallel slots are located perpendicular to the longitudinal dimension of the sheet and extending only part way between longitudinal borders at each longitudinal edge of the sheet, and wherein each edge perpendicular to the sheet's longitudinal dimension has a flat border.

36. The sheet of claim 35, wherein the length is about one to about five inches, the width is about 0.5 inch to about five inches, and the thickness is about 0.001 inch to about 0.01 inch.

37. A fuel cell that comprises
a proton exchange membrane (“PEM”) sheet having an anode face, a cathode face, and an inactive border around the sheet's perimeter, wherein a seal is positioned around the border of the anode face;
a bipolar separator plate (“BSP”) having about the same dimensions as the PEM sheet, the BSP having interconnected channels in the face of the plate for positioning adjacent the anode face of the PEM sheet, a entrance orifice leading to the channels to direct a fuel source to the anode face, the channels having flat raised surfaces between the channels, an exit orifice leading from the channels for releasing reaction products from the anode face, and a border around the BSP's perimeter to sealingly receive a seal between the perimeter border of the BSP and the anode face of the PEM sheet,
a plurality of conductive sleeves as defined in claim 50 positioned across the cathode face of the PEM so that the continuous, longitudinal flat metal surfaces of the conductive sleeve are against the cathode face and the plurality of slots are aligned parallel to the channels and the parallel metal strips across the face of the sleeve are aligned with the flat raised surfaces between the channels of the BSP;
two manifold assembly devices (“MADs”) positioned at opposite ends of the fuel cell so that the top surfaces of each of the MADs are about level with the faces of the sleeves and the opposite surfaces of the MADs are tightly positioned against the inactive border of the cathode face of the PEM,
wherein on the end of the fuel cell having the entrance orifice leading to the channels, the MAD provides a passage to the entrance orifice, and on the end of the fuel cell having the exit orifice, the MADs provide a passage from the exit orifice to the atmosphere, so that when a fuel source is provided to the cell through the entrance orifice, it flows through the channels to contact the anode face of the PEM and at the same time an oxygen source flows through the sleeves to contact the cathode face to induce the flow of protons across the PEM and an electric current to flow from the anode to the cathode when a circuit is set up.

38. A fuel cell stack that comprises a plurality of fuel cells of claim 37 layered together in the following sequence:
a backplate comprising a BSP with a channeled face,
a PEM with its anode face against the BSP's channeled face,
a seal between the perimeter borders of the BSP and the PEM,
a set of MADs and the conductive sleeves positioned on the cathode face, and repeating this sequence.

39. The fuel cell stack of claim 38 positioned on a mounting plate and having an electrical circuit established between the anode and cathodes of the PEMs.

40. The fuel cell stack of claim 38 designed to provide a system of 12 volts or multiples thereof.

41. The fuel cell of claim 37, wherein a flexible, contoured seal is attached around the perimeter border of the channeled face of the BSP and a complementary flexible, contoured seal is attached around the perimeter border of the PEM.

42. The fuel cell of claim 41, wherein the complementary seals of the BSP and PEM interlock when compressed against each other to form an air-tight seal.

43. The fuel cell stack of claim 38, wherein the MADs facilitate gas-tight flow throughout the fuel cell stack to each anode face of the proton exchange membrane and the channels of the bipolar separator plate.

44. The fuel cell stack of claim 38, wherein the MADs thickness is dimensioned to control the amount of compression force on the sleeves.

45. The fuel cell stack of claim 38, wherein surfaces of the MADs have grooves molded or machined into them to capture an interlocking seal and compress the assembly to force a seal.
